(19) United States
(12) Patent Application Publication
(10) Pub. No.: US 2014/0004372 A1
(43) Pub. Date: Jan. 2, 2014

(54) CHROMIUM DIFFUSION COATING

(71) Applicants: Kevin L. Collins, Mansfield, TX (US); Michael J. Minor, Arlington, TX (US)

(72) Inventors: Kevin L. Collins, Mansfield, TX (US); Michael J. Minor, Arlington, TX (US)

(21) Appl. No.: 13/536,141

(22) Filed: Jun. 28, 2012

(51) Int. Cl. B05D 3/02; C09D 5/00; B32B 15/04

(52) U.S. Cl. 428/559; 427/383.1; 427/256; 106/287.17

(57) ABSTRACT

A method of diffusion coating an article includes applying a mixture to an article. The mixture consists essentially of an active coating metal of chromium powder, alumina powder, a diffusion activator of chromium(III) chloride and an organic carrier material. The article is then heated at a diffusion temperature to cause diffusion of the chromium powder into the article to form a diffusion coating on the article.

### BACKGROUND

This disclosure relates to improvements in forming chromium diffusion coatings.

Articles that are subject to corrosion, such as gas turbine engine components, may include a coating to protect an underlying material from corrosion. Vapor deposition techniques can be used to deposit chromium for diffusion into the underlying material. However, if the coating is to be applied only to specific, localized areas of the article, masking off the areas that are not to be coated is ineffective because chromium vapor in the vapor deposition infiltrates under the maskant.

Alternatively, there is a slurry technique for applying a diffusion coating. For instance, the slurry includes active metals that are to be diffused into the component, an activator such as ammonium chloride, inert material such as alumina and a binder to hold the other constituents of the slurry together. A challenge in using this slurry technique, however, is that the active metals diffuse laterally with regard to the area on which the slurry is applied such that the resulting diffusion coating is formed over an uncontrolled area that is larger than desired.

### SUMMARY

A method of diffusion coating an article according to an exemplary aspect of the present disclosure includes applying a mixture to an article. The mixture consists essentially of an active coating metal of chromium powder, alumina powder, a diffusion activator of chromium(III) chloride and an organic carrier material. The article is then heated at a diffusion temperature to cause diffusion of the chromium powder into the article to form a diffusion coating on the article.

In a further non-limiting embodiment, relative to a total combined weight of the chromium powder, the alumina powder and the diffusion activator of chromium(III) chloride, the mixture has 1.5-1.7% by weight of the chromium(III) chloride.

In a further non-limiting embodiment of any of the foregoing examples, relative to a total combined weight of the chromium powder, the alumina powder and the chromium(III) chloride, the mixture has 25-60% by weight of the chromium powder, 1.5-1.7% by weight of the chromium(III) chloride and a balance of the alumina powder.

In a further non-limiting embodiment of any of the foregoing examples, the mixture has 50% or less by weight of the chromium powder.

In a further non-limiting embodiment of any of the foregoing examples, the article is made of a nickel-based super alloy.

In a further non-limiting embodiment of any of the foregoing examples, the heating of the article includes heating in an argon environment.

In a further non-limiting embodiment of any of the foregoing examples, the diffusion temperature is greater than 1900° F./1030° C.

In a further non-limiting embodiment of any of the foregoing examples, relative to a total combined weight of the chromium powder, the alumina powder and the chromium(III) chloride, the mixture has X % by weight of the chromium powder and Z % by weight of the chromium(III) chloride such that a ratio of X/Z is between 14 and 40.

In a further non-limiting embodiment of any of the foregoing examples, the chromium powder and the alumina powder each have −325 mesh powder size.

A further non-limiting embodiment of any of the foregoing examples includes applying the mixture to a localized portion of the article.

An article for diffusion coating according to an exemplary aspect of the present disclosure includes forming a mixture consisting essentially of an active coating metal of chromium powder, alumina powder, a diffusion activator of chromium(III) chloride and an organic carrier material, and applying the mixture on an article that is to be diffusion coated.

In a further non-limiting embodiment of any of the foregoing examples, relative to a total combined weight of the chromium powder, the alumina powder and the diffusion activator of chromium(III) chloride, the mixture has 1.5-1.7% by weight of the chromium(III) chloride.

In a further non-limiting embodiment of any of the foregoing examples, relative to a total combined weight of the chromium powder, the alumina powder and the chromium(III) chloride, the mixture has 25-60% by weight of the chromium powder, 1.5-1.7% by weight of the chromium(III) chloride and a balance of the alumina powder.

In a further non-limiting embodiment of any of the foregoing examples, the article is made of a nickel-based superalloy.

In a further non-limiting embodiment of any of the foregoing examples, relative to a total combined weight of the chromium powder, the alumina powder and the chromium(III) chloride, the mixture has X % by weight of the chromium powder and Z % by weight of the chromium(III) chloride such that a ratio of X/Z is between 14 and 40.

An article for diffusion coating according to an exemplary aspect of the present disclosure includes a surface that is to be diffusion coated and a mixture disposed on the surface to be diffusion coated. The mixture consists essentially of an active coating metal of chromium powder, alumina powder, a diffusion activator of chromium(III) chloride and an organic carrier material.

In a further non-limiting embodiment of any of the foregoing examples, relative to a total combined weight of the chromium powder, the alumina powder and the diffusion activator of chromium(III) chloride, the mixture has 1.5-1.7% by weight of the chromium(III) chloride.

In a further non-limiting embodiment of any of the foregoing examples, relative to a total combined weight of the chromium powder, the alumina powder and the chromium(III) chloride, the mixture has 25-60% by weight of the chromium powder, 1.5-1.7% by weight of the chromium(III) chloride and a balance of the alumina powder.

In a further non-limiting embodiment of any of the foregoing examples, the article is made of a nickel-based super alloy.

In a further non-limiting embodiment of any of the foregoing examples, relative to a total combined weight of the chromium powder, the alumina powder and the chromium(III) chloride, the mixture has X % by weight of the chromium powder and Z % by weight of the chromium(III) chloride such that a ratio of X/Z is between 14 and 40.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example method of diffusion coating an article.

FIG. 2 illustrates an example method of preparing an article for diffusion coating.

FIG. 3 shows an example article that is prepared for diffusion coating.

### DETAILED DESCRIPTION

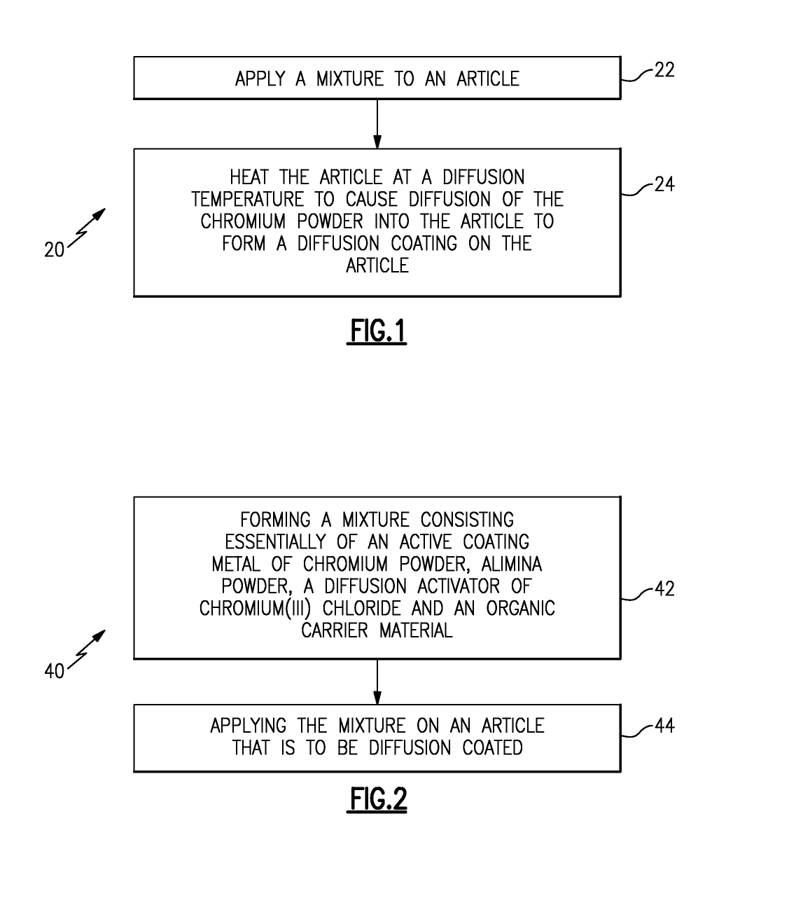

FIG. 1 illustrates an example method 20 of diffusion coating an article, such as an article made of a nickel-based superalloy. As will be described, the method 20 involves the use of a mixture that is tailored to provide effective chromium diffusion into the nickel-based superalloy of the article, while reducing lateral “smearing” of the resulting diffusion coating.

In this example, the method 20 includes an application step 22 and a heating step 24. The application step 22 includes applying the mixture to the article, such as by painting the mixture onto the article, dipping the article in the mixture or spraying the mixture onto the article.

After the application step 22, the article is heated in the heating step 24 to diffuse the chromium powder into the article to form the chromium diffusion coating. As an example, the heating is conducted in a furnace having a continual flow of argon to produce an argon environment, in which argon is the most abundant gas, at a temperature greater than 1900° F./1038° C., such as 1950° F./1066° C. to 2000° F./1094° C. The article is heated for a selected amount of time, depending upon a desired thickness of the resulting chromium diffusion coating. In some examples, the selected amount of time is between 6 and 16 hours and the final chromium diffusion coating (layer) includes at least 20% by weight of chromium. Alternatively, the article may first be heated in the heating step 24 and the mixture then applied to the article once heated.

The mixture consists essentially of an active coating metal of chromium powder, alumina powder, a diffusion activator of chromium(III) chloride, which can be provided in a powder form, and an organic carrier material. For example, the mixture may include only the listed constituents and inadvertent impurities that do not influence the properties of the mixture. The chromium powder and the alumina powder each have a −325 mesh powder size. In one example, the organic carrier material is B-4 carrier material (APV Engineered Coatings), but other organic carrier materials can be used.

The composition of the mixture is tailored for effective diffusion of the chromium powder into the article over a controlled area. As an example, where there is a desire to apply a chromium diffusion coating over only a localized portion of the article, the mixture is applied only to the area to be coated and diffuses into the applied area with little lateral diffusion. For example, any remnant vapor generated from the mixture during heating is carried away in the argon environment such that the vapor does not deposit outside of the applied area. Thus, the diffusion is limited to the applied area rather than “smearing” laterally. The mixture thus provides better control over the size of the coated area. To this end, the mixture has, relative to a total combined weight of the chromium powder, the alumina powder and the chromium(III) chloride, 1.5-1.7% by weight of the chromium(III) chloride. Other activators, such as other halide-based activators, vary in effectiveness with regard to different active coating metals, including chromium. However, the chromium(III) chloride, in the prescribed amount, is particularly effective for facilitating the diffusion of chromium powder into nickel-based superalloys.

In a further example, the mixture, again relative to the total combined weight, also has 25-60% by weight of the chromium powder and a remainder of the alumina powder. In one further example, the chromium powder, relative to the total combined weight, is present in an amount of 50% or less by weight.

In a further example, the mixture, again relative to the total combined weight, also has about 25% to about 60% by weight of the chromium powder and a remainder of the alumina powder. In one further example, the chromium powder, relative to the total combined weight, is present in an amount of about 50% or less by weight.

The amounts of the chromium(III) chloride diffusion activator and the chromium powder are selected in correspondence, for effective diffusion and area control. The relationship between the amount of the chromium powder and the amount of the chromium(III) chloride can be represented as a ratio. For instance, the mixture, relative to the total combined weight, includes X % by weight of the chromium powder and Z % by weight of the chromium(III) chloride in a ratio of X/Z that is between 14 and 40. Providing the chromium powder and the chromium(III) chloride in ratio described ensures effective diffusion of the chromium powder into the article and control over the area of the article into which the chromium powder diffuses. That is, the mixture herein limits lateral diffusion that would otherwise enlarge the coating area.

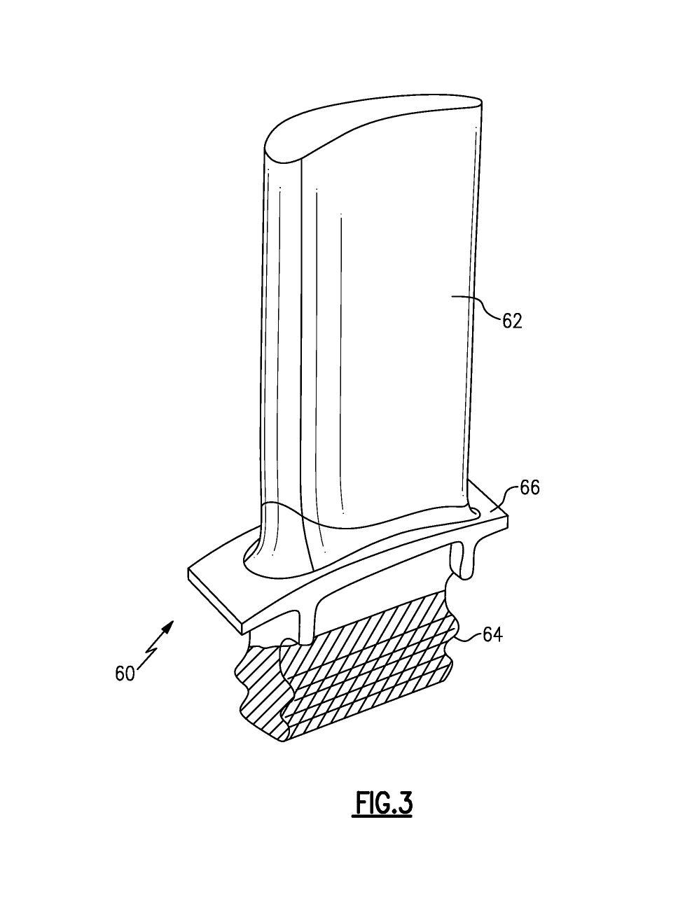

FIG. 2 illustrates a related method 40 that can be used in conjunction with the method 20, for example. The method 40 includes a forming step 42 and an application step 44. The application step 44 is similar to the application step 22 described above.

The forming step 42 includes forming the mixture, with the composition as described above. As an example, the organic carrier material is a liquid material to which the chromium powder, the alumina powder and the chromium(III) chloride (powder) are added in order to form the mixture. The amount of organic carrier material that is used in the mixture can be varied, depending upon the desired viscosity or texture of the mixture. That is, a greater amount of the organic carrier material may be used to produce a more fluid mixture (e.g., a slurry). Alternatively, a lesser amount of the organic carrier material can be used to form a less fluid, or semi-solid, mixture. In the method 40, the article may then subsequently be heated as in the heating step 24 of the method 20. Similarly, in further examples, the method 20 may include the forming step 42 of method 40, prior to the application step 22.

FIG. 3 shows an article 60, which in this example is a gas turbine engine turbine blade. It is to be understood, however, that the methods 20 and 40 will also benefit other articles or other gas turbine engine components. The article 60 has been prepared for diffusion coating by applying the mixture onto a portion of the article 60 according to the application step 22.

In this example, the article 60 generally includes an airfoil portion 62 and a root portion 64. The airfoil portion 62 extends outwardly from one side of a platform portion 66 and the root portion 64 extends outwardly on an opposite side of the platform portion 66. Here, a chromium diffusion coating is to be applied only to the root portion 64 and thus a mixture 68 is applied only to the root portion 64, as indicated by the cross-hatching in the drawing. The article 60 is thus ready for diffusion coating according to the heating step 24 of method 20.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A method of diffusion coating an article, the method comprising:
applying a mixture to an article, the mixture consisting essentially of an active coating metal of chromium powder, alumina powder, a diffusion activator of chromium(III) chloride and an organic carrier material; and
heating the article at a diffusion temperature to cause diffusion of the chromium powder into the article to form a diffusion coating on the article.

2. The method as recited in claim 1, wherein, relative to a total combined weight of the chromium powder, the alumina powder and the diffusion activator of chromium(III) chloride, the mixture has 1.5-1.7% by weight of the chromium(III) chloride.

3. The method as recited in claim 1, wherein, relative to a total combined weight of the chromium powder, the alumina powder and the chromium(III) chloride, the mixture has 25-60% by weight of the chromium powder, 1.5-1.7% by weight of the chromium(III) chloride and a balance of the alumina powder.

4. The method as recited in claim 3, wherein the mixture has 50% or less by weight of the chromium powder.

5. The method as recited in claim 1, wherein the article is made of a nickel-based superalloy.

6. The method as recited in claim 1, wherein the heating of the article includes heating in an argon environment.

7. The method as recited in claim 6, wherein the diffusion temperature is greater than 1900° F./1030° C.

8. The method as recited in claim 1, wherein, relative to a total combined weight of the chromium powder, the alumina powder and the chromium(III) chloride, the mixture has X % by weight of the chromium powder and Z % by weight of the chromium(III) chloride such that a ratio of X/Z is between 14 and 40.

9. The method as recited in claim 1, wherein the chromium powder and the alumina powder each have a −325 mesh powder size.

10. The method as recited in claim 1, further comprising applying the mixture to a localized portion of the article.

11. A method of preparing an article for diffusion coating, the method comprising:
forming a mixture consisting essentially of an active coating metal of chromium powder, alumina powder, a diffusion activator of chromium(III) chloride and an organic carrier material; and
applying the mixture on an article that is to be diffusion coated.

12. The method as recited in claim 11, wherein, relative to a total combined weight of the chromium powder, the alumina powder and the diffusion activator of chromium(III) chloride, the mixture has 1.5-1.7% by weight of the chromium(III) chloride.

13. The method as recited in claim 11, wherein, relative to a total combined weight of the chromium powder, the alumina powder and the chromium(III) chloride, the mixture has 25-60% by weight of the chromium powder, 1.5-1.7% by weight of the chromium(III) chloride and a balance of the alumina powder.

14. The method as recited in claim 11, wherein the article is made of a nickel-based superalloy.

15. The method as recited in claim 11, wherein, relative to a total combined weight of the chromium powder, the alumina powder and the chromium(III) chloride, the mixture has X % by weight of the chromium powder and Z % by weight of the chromium(III) chloride such that a ratio of X/Z is between 14 and 40.

16. An article for diffusion coating, the article comprising:
a body including a surface that is to be diffusion coated; and
a mixture disposed on the surface that is to be diffusion coated, the mixture consisting essentially of an active coating metal of chromium powder, alumina powder, a diffusion activator of chromium(III) chloride and an organic carrier material.

17. The article as recited in claim 16, wherein, relative to a total combined weight of the chromium powder, the alumina powder and the diffusion activator of chromium(III) chloride, the mixture has 1.5-1.7% by weight of the chromium(III) chloride.

18. The article as recited in claim 16, wherein, relative to a total combined weight of the chromium powder, the alumina powder and the chromium(III) chloride, the mixture has 25-60% by weight of the chromium powder, 1.5-1.7% by weight of the chromium(III) chloride and a balance of the alumina powder.

19. The article as recited in claim 16, wherein the article is made of a nickel-based superalloy.

20. The article as recited in claim 16, wherein, relative to a total combined weight of the chromium powder, the alumina powder and the chromium(III) chloride, the mixture has X % by weight of the chromium powder and Z% by weight of the chromium(III) chloride such that a ratio of X/Z is between 14 and 40.
